(19) United States
(12) Patent Application Publication
(10) Pub. No.: US 2005/0272630 A1
(43) Pub. Date: Dec. 8, 2005

(54) Binary surfactant systems for developing extensional viscosity in cleaning compositions

(76) Inventors: Inderjeet Ajmani, Pleasanton, CA (US); Lucia Tin, Carlsbad, CA (US); Clement K. Choy, Alamo, CA (US)

Correspondence Address: THE CLOROX COMPANY, 1221 BROADWAY PO BOX 2351, OAKLAND, CA, 94623, US

(21) Appl. No.: 10/859,646

(22) Filed: Jun. 2, 2004

(51) Int. Cl. C11D 1/00

(52) U.S. Cl. 510/499

(57) ABSTRACT

The present invention relates to cleaning compositions having a viscoelastic rheology and, in particular, to hypochlorite compositions having a viscoelastic rheology, which compositions are formulated to have optimized viscosity together with optimized elasticity. The present invention affords a range of rheologies for simultaneously achieving optimal viscosity and optimal elasticity. The inventive composition also provides, when formulated as a drain opener, the advantage of ready penetration through standing water, as well as adherence to partial clogs.

### BACKGROUND OF THE INVENTION

1. Field of the Invention

The present invention relates to cleaning compositions having viscoelastic rheology and, in particular, to hypochlorite compositions having a viscoelastic rheology, which compositions are formulated to have optimized viscosity together with optimized elasticity.

2. Description of the Pertinent Art

Much of the prior art has addressed the problem of developing thickening systems for use in certain compositions, which may optionally contain cleaning actives such as bleaching agents, and which are used as hard surface cleaning compositions or cleansers. Cleansers having increased viscosities are particularly beneficial for use on cleaning vertical or inclined surfaces, or in formulations designed for delivery through standing water such as clogged drain openers. The efficacy of such cleaning compositions and formulations is greatly improved by viscous compositions due, in part, to increased residence time of the cleaner. Other problems associated with non-viscous compositions, such as misting of the product and drift to unprotected surfaces, as well as undesired sputtering during application and use, can also be minimized. Other art has addressed the formulation of thickened cleaners for drain opening purposes. Viscoelastic formulations have been described for such purpose, however formulations of the art are not optimized to be effective on both full clogs (wherein flow is blocked) and partial (slow flowing) clogs. Viscous formulations tend to perform best on partial clogs due to their ability to adhere to the clog material, while more elastic formulations are superior in removing full clogs, due to their ability to penetrate standing water.

Rörig, et al., U.S. Pat. No. 4,842,771 disclose a tertiary amine oxide containing at least one alkyl group of C₁₆ or higher in combination with cumene-, xylene- or toluene sulfonate, but also requires 1-5% of an acid such that the pH does not exceed about 6. Rörig, et al., therefore exclude the possibility of alkaline cleaners. Rose, et al., U.S. Pat. No. 4,800,036, describe viscoelastic hypochlorite solutions thickened with “onium surfactant ions” and aromatic sulfonate or carboxylate counterions, where the onium moiety is a quaternary ammonium group.

U.S. Pat. Nos. 4,900,467 and 5,389,157 to Smith (incorporated by reference herein, and assigned to the assignee of the invention herein) both describe systems having a viscous rheology, preferably one with an elastic component, most preferably a viscoelastic rheology, imparted by a binary system including a betaine or sulfobetaine having a C₁₄₋₁₈ alkyl group, or a C₁₀₋₁₈ alkylamino or alkylamido group, and an anionic organic counterion that is thought to promote elongated micelles. Smith, U.S. Pat. No. 5,389,157, discloses a viscoelastic cleaner/drain opener consisting of a betaine plus organic counterion, and having a specified rheology. Choy et al, U.S. Pat. No. 5,916,859 describes a hexadecyl amine oxide/counterion composition and method for developing extensional viscosity in cleaning compositions. Rader et al, U.S. Pat. No. 5,833,764 and U.S. Pat. No. 5,336,426 describe a method for opening drains using phase stable viscoelastic cleaning compositions consisting of quaternary ammonium compounds and organic counterions under conditions of restricted free amine. The disclosures of the above-cited Choy et al and Rader et al patents are owned by the assignee of the invention herein, and are fully incorporated by reference. The art is, however, deficient in teaching a drain-opening formulation which is optimized for performance on both full and partial clogs.

### SUMMARY OF THE PRESENT INVENTION

The present invention affords a range of rheologies for simultaneously achieving optimal viscosity and optimal elasticity. The inventive composition also provides, when formulated as a drain opener, the advantage of ready penetration through standing water, as well as adherence to partial clogs. By adhering to partial clogs, the formulations of the present invention provide a high level of active contact, or “dwell” time.

The viscoelastic properties of a fluid can be measured with instruments such as a Bohlin VOR rheometer. A frequency sweep with a Bohlin rheometer can produce oscillation data which, when applied to a Maxwell model, result in parameters such as relaxation time (Tau) measured in secondes, and static shear modulus (G₀), measured in Pascals. Since the static shear modulus is a measure of the resistance to flow, the ratio of the relaxation time (Tau) to the static shear modulus (G₀) is used to measure relative elasticity. The relaxation times of the formulations of the present invention are selected to be between about 0.5-20 seconds, or between about 1-15 seconds, or between about 1-10 seconds. G₀ is selected to be between about 0.2-15 Pascals (Pa), or between about 0.5-10, or between 1-8 Pa. Relative elasticity may be selected to be between about 0.1-8 sec/Pascal (Pa); or about 0.2-5 sec/Pa, or about 0.3-4 sec/Pa. Instruments capable of performing oscillatory or controlled stress creep measurements can be used to quantify elasticity. Some parameters can be measured directly or they can be calculated using models. Increasing relaxation times indicate increasing elasticity, but elasticity can be moderated by increasing the resistance to flow. Tau and G₀ can also be calculated from oscillation data using the Maxwell model. Tau can also be calculated by taking the inverse of the frequency with the maximum loss modulus. G₀ is then obtained by dividing the complex viscosity by Tau. For purposes of the present invention, the G₀ measurement correlates with viscosity, while Tau correlates with elasticity.

It is therefore an object of the present invention to provide a thickened hypochlorite composition, which can be formulated as a drain opener, and which simultaneously achieves a higher viscosity and a lower viscoelasticity, compared with drain openers of the prior art.

It is yet another object of the present invention to provide a hypochlorite drain opening composition which readily penetrates standing water, yet which also adheres to and reacts with clogs.

It is another object of the present invention to provide a stable thickened hypochlorite composition with a viscoelastic rheology for increased drain opening efficacy.

Briefly, one embodiment of the present invention comprises a thickener having a viscoelastic rheology wherein the rheology is defined by: a Tau value of between about 0.5 and 20 seconds, a G₀ value between about 0.2-15 Pa, a Tau/G₀ of about 0.1-8 sec/Pa, and a viscosity of less than about 4000 cP. Optionally, a cleaning active is included with, or forms a part of the thickener.

Another embodiment of the present invention comprises a stable cleaning composition having a viscoelastic rheology comprising, in aqueous solution:
a viscoelastic thickening system comprising at least a hexadecyl dialkyl amine oxide, a tetradecyl dialkyl amine oxide and an organic counterion, and, optionally, an active cleaning compound.

A number of additional components may be added to improve or enhance stability, rheology, efficacy and/or aesthetics or consumer acceptance of a commercial product.

Viscoelasticity may be imparted to the composition by a mixed surfactant system. In one embodiment of the present invention, the mixed surfactant system includes at least a hexadecyl dialkyl amine oxide, a tetradecyl dialkyl amine oxide and an organic counterion. The viscosity of the formulations of the present invention can range from slightly greater than that of water, to several thousand centipoise (cP). A first exemplary range is about 20 cP to 4000 cP; a second exemplary range is 50 cP to 3000 cP; and a third exemplary range is 100 cP to 2000 cP. An exemplary range for Tau is 0.5 to about 20 seconds; an exemplary range for G₀ is 0.2 to about 15 Pascals. An exemplary Tau/G₀ range is about 0.1 to 8 sec/Pa.

It is an advantage of the present invention that the composition rheology is optimizable for both viscosity and elasticity.

It is another advantage of the present invention that the viscoelastic thickener is chemically and phase-stable in the presence of a variety of cleaning actives, including hypochlorite, and retains such stability at both high and low temperatures.

It is yet another advantage of the composition of the present invention that the desired rheology is achieved with relatively low levels of surfactant, improving chemical and physical stability.

These and other objects and advantages of the present invention will no doubt become apparent to those skilled in the art after reading the following Detailed Description of the Preferred Embodiments.

### DETAILED DESCRIPTION OF THE PREFERRED EMBODIMENTS

In the Drawings

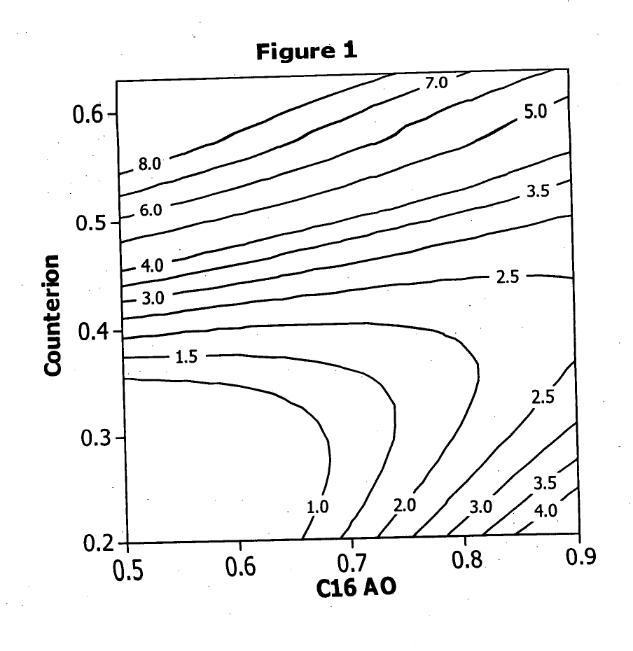

FIG. 1 is a contour plot of Tau for various levels of C₁₆ amine oxide and counterion at a constant level of C₁₄ amine oxide;

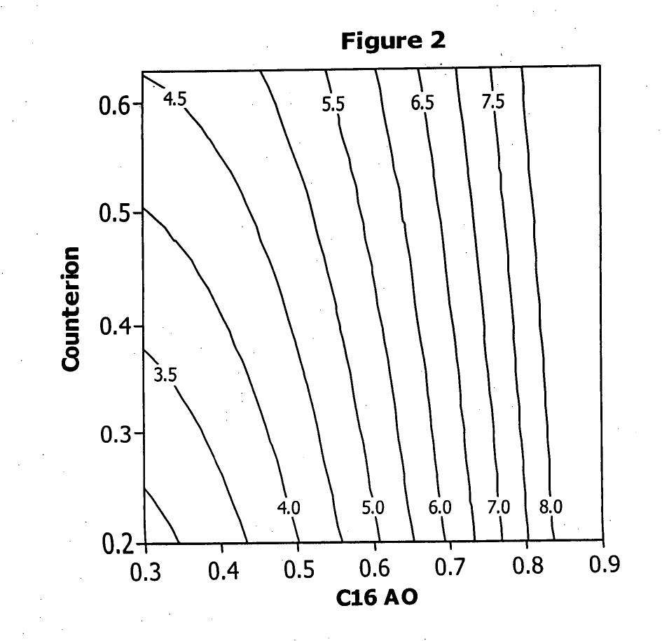

FIG. 2 is a contour plot of G₀ for various levels of C₁₆ amine oxide and counterion at a constant level of C₁₄ amine oxide;

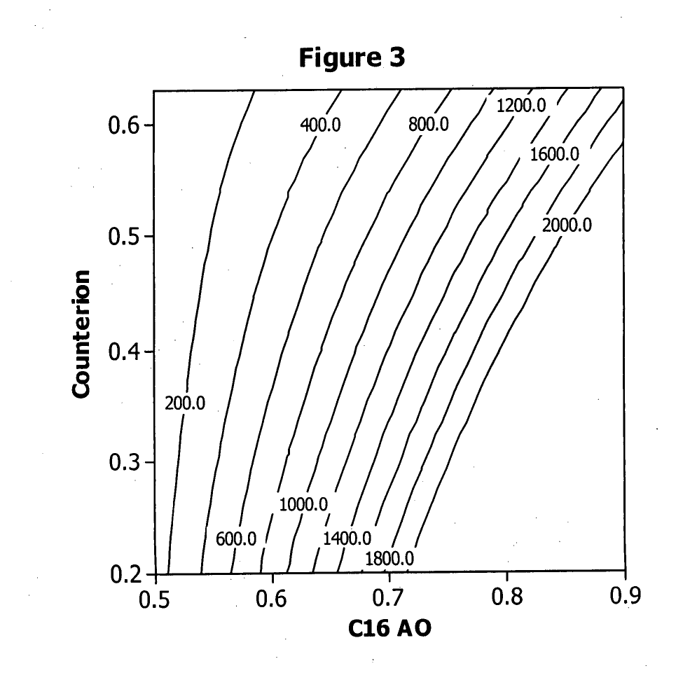

FIG. 3 is a contour plot of viscosity for various levels of C₁₆ amine oxide and counterion at a constant level of C₁₄ amine oxide;

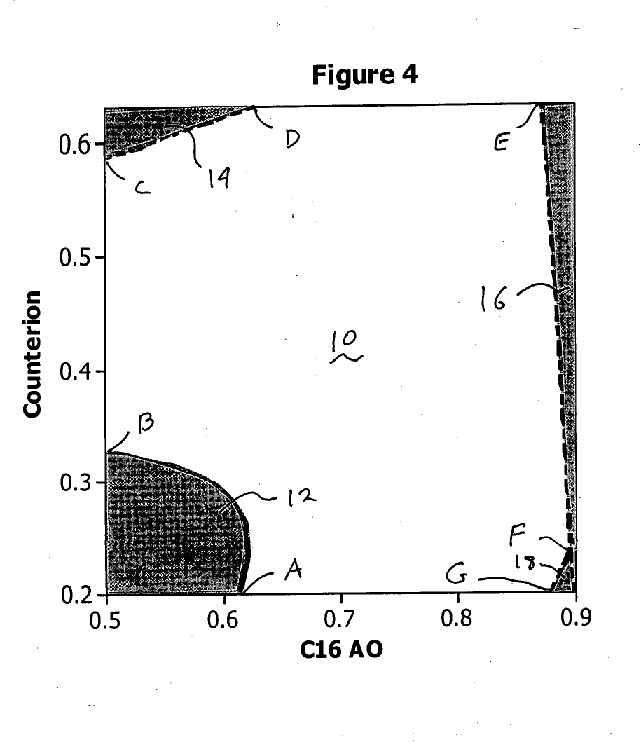

FIG. 4 is a overlaid contour plot of Tau, G₀ and viscosity for various levels of C₁₆ amine oxide and counterion at a constant level of C₁₄ amine oxide; and

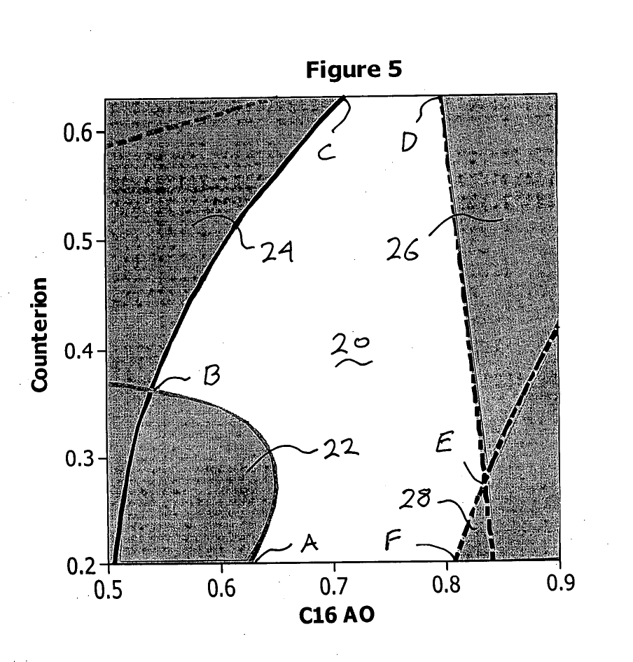

FIG. 5 is a overlaid contour plot of Tau, G₀ and viscosity for various levels of C₁₆ amine oxide and counterion at a constant level of C₁₄ amine oxide.

### DEFINITIONS

“Micelles” as used herein are structures that form spontaneously by the self-association of individual moieties, such as surfactant molecules, in a liquid medium. These molecular aggregates are in equilibrium with monomeric, or dissolved (but un-associated) surfactant molecules above a certain concentration for a given surfactant (also known as the critical micelle concentration or CMC) in a given temperature range. “Normal” micelles are characterized by relatively hydrophobic core regions comprised of lippophilic parts of surfactants that avoid contact with water as much as possible, and hydrophilic regions formed by lippophobic ends of the molecules. Depending on the number of surfactant molecules in the aggregate, micellar shapes can vary from spheres to oblate or prolate ellipsoids, including elongated or rod-like micelles, and discs.

That term “viscoelastic” refers to liquids that exhibit a combination of behavior characterized as both viscous, that is, liquid-like in that energy is dissipated through the liquid and elastic, that is, solid-like in that energy is stored in the fluid. Viscoelastic is used herein in general association with the cleaning for relations at the present invention.

In one embodiment of the present invention comprises a composition having a viscoelastic rheology wherein the rheology is defined by: a Tau value of between about 0.5 and 20 seconds, a G₀ value of 0.25 to 15 Pa, and a viscosity of less than about 4000 cP. This embodiment is further defined by reference to the drawing Figures, and in particular with reference to FIGS. 4 and 5. The Figures depict rheological plots of the formulation of Table I below, with variations shown in sodium xylene sulfonate (SXS) counterion, and C₁₆ amine oxide.

FIG. 1 illustrates values for Tau as a function of amounts of counterion and C₁₆ amine oxide. In one embodiment of the invention, Tau values are selected to be above 1, and below 13. FIG. 2 illustrates values for G₀ as a function of amounts of counterion and amine oxide. In one embodiment of the invention, G₀ values are selected to be above 2, and below 9. FIG. 3 illustrates values for viscosity as a function of amounts of counterion and amine oxide. In one embodiment of the invention, viscosity values are selected to be above 200, and below 3000 cP. FIG. 4 is an overlaid contour plot of viscosity, G₀ and Tau as a function of amounts of counterion and C₁₆ amine oxide. In one embodiment of the invention, viscosity values are selected to be below 4000, while Tau is selected to be above 10. In FIG. 4, an inventive range of operability 10 is defined by the area bounded by points A, B, C, D, E F and G (the unshaded region of the Figure.) In FIG. 5, an inventive range of operability 20 is defined by the area bounded by points A, B, C, D, E and F (the unshaded region of the Figure.) Referring to FIG. 4, the shaded region 12, defined by the curve connecting points A and B, represents a Tau of 0.4 seconds or less. The shaded region 14, defined by the curve connecting points C and D, represents a Tau of ten seconds or greater. The shaded region 16, defined by the curve connecting points E and F, represents a G₀ of 9 Pa or greater. The shaded region 18, defined by the curve connecting points F and G, represents a viscosity of 4000 cP or higher. Referring to FIG. 5, the shaded region 22, defined by the curve connecting points A and B, represents a Tau of 1 second or less. The shaded region 24, defined by the curve connecting points B and C, represents a viscosity of 500 cP or less. The shaded region 26, defined by the curve connecting points D and E represents a G₀ of 8 Pa or greater. The shaded region 28, defined by the curve connecting points E and F, represents a viscosity of 3000 cP or higher. The inventive composition having the defined rheology may be used in a variety of applications, including thickening, flow modification and mist suppression. It may be itself used to achieve beneficial results in cleaning, sanitizing, disinfecting and treating surfaces, or may be combined with other actives, as herein described, to achieve these and other purposes.

While the Figures reflect rheological parameters obtained by particular formulations, it is to be understood that the present invention is defined by said rheological parameters, and the formulations are understood to be examples of one way in which said rheological parameters can be obtained, but it is within the intended scope of the invention to obtain the operative rheologies independently of a particular formulation.

In another embodiment, the present invention is a thickened viscoelastic cleaning composition comprising, in aqueous solution:
a viscoelastic thickening system comprising at least a hexadecyl dialkyl amine oxide, at least a tetradecyl dialkyl amine oxide, and an organic counterion; and optionally, an active cleaning compound.

A number of additional components may be added to improve or enhance stability, rheology, efficacy and/or aesthetics or consumer acceptance of a commercial product.

### Active Cleaning Compounds

A number of cleaning compounds are known and are compatible with the viscoelastic thickener. Such cleaning compounds interact with their intended target materials either by chemical or enzymatic reaction or by physical interactions, which are hereinafter collectively referred to as reactions. Useful reactive compounds include acids, bases, oxidants, reductants, solvents, enzymes, thioorganic compounds, surfactants (detergents) and mixtures thereof. Examples of enzymes include proteases, amylases, and cellulases. Useful solvents include saturated hydrocarbons, ketones, carboxylic acid esters, terpenes, glycol ethers, and the like. Oxidants, e.g. bleaches, are a preferred cleaning active, and may be selected from various halogen or peroxygen bleaches. Particularly preferred is a halogen bleach source which may be selected from various hypochlorite-producing species, for example, bleaches selected from the group consisting of the alkali metal and alkaline earth salts of hypohalite, haloamines, haloimines, haloimides and haloamides. All of these are believed to produce hypohalous bleaching species in situ. Hypochlorite and compounds producing hypochlorite in aqueous solution are preferred, although hypobromite is also suitable. Representative hypochlorite-producing compounds include sodium, potassium, lithium and calcium hypochlorite, chlorinated trisodium phosphate dodecahydrate, potassium and sodium dicholoroisocyanurate and trichlorocyanuric acid. Organic bleach sources suitable for use include heterocyclic N-bromo and N-chloro imides such as trichlorocyanuric and tribromocyanuric acid, dibromo and dichlorocyanuric acid, and potassium and sodium salts thereof, N-brominated and N-chlorinated succinimide, malonimide, phthalimide and naphthalimide. Also suitable are hydantoins, such as dibromo and dichlorodimethylhydantoin, chlorobromo-dimethylhydantoin, N-chlorosulfamide (haloamide) and chloramine (haloamine). Particularly preferred in this invention is sodium hypochlorite having the chemical formula NaOCl, in an amount ranging from about 0.1 weight percent to about 15 weight percent, more preferably about 0.2% to 10%, and most preferably about 2.0% to 6.0%.

### Hexadecyl Amine Oxide

As mentioned hereinabove, the surfactant suitable for use in this invention is a bleach-stable nonionic amine oxide, especially a trialkyl amine oxide. A representative structure is set forth below:

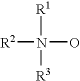

In the structure above, R² is 16 carbon alkyl, and R¹ and R³ are each 1 to 2 carbons, and are most preferably methyl. When R¹ and R³ are both methyl and R² is alkyl averaging 16 carbon atoms, the structure for dimethylhexadecylamine oxide, a particularly preferred amine oxide, is obtained. Representative examples of this particular bleach-stable nonionic surfactant include those sold under the trademark AMMONYX® CO by Stepan Chemical Company, and BARLOX® 16S by Lonza Corporation. The R² group is preferably straight-chained, although some degree of branching is acceptable at about the gamma carbon or further. Generally, the more distal the carbon relative to the amine group, the longer the branched chain may be. Amine oxides having a branched R group are thus considered to be within the scope of the present invention as long as the longest chain of the branched R group contains no more than 16 carbons. The hexadecyl amine oxide is present in a viscosity-developing effective amount. A first viscosity developing range is 0.1-5.0 percentage by weight of the composition. In general, higher viscosities are developed at higher weight percentages of C₁₆ amine oxide.

The hexadecyl amine oxide may contain a relatively high percentage of the C₁₆ alkyl group (as considered prior to mixing with tetradecyl amine oxide). In a first embodiment, the amine oxide is about 80% C₁₆; in a second embodiment the amine oxide is about 95% C₁₆; and in a third is about 99% C₁₆. Expressed alternatively, a value for the actual amount of C₁₆ amine oxide (A_{cs}) is the product of total C₁₆ (expressed in weight percentage) and the fraction of C₁₆ amine oxide (expressed as a ratio of C₁₆ to total amine oxide.) The foregoing weight percentages are intended to be exemplary; the amount of C₁₆ amine oxide is defined by the desired rheological parameters of Tau, G₀, Tau/G₀ and viscosity as taught herein.

In general, the degree of extensional viscosity buildup is obtained by comparing the extensional viscosity with the shear viscosity (i.e. “normal” viscosity as measured with a Brookfield viscometer). Values for Tau and G₀ were obtained using a Bohlin rheometer. Water, for instance, will have a ratio of extensional to shear viscosity (a Trouton ratio) of 3, regardless of the rates of shearing or extending. Systems which exhibit extensional properties are non-Newtonian systems, in which the viscosity is a function of the shear.

### Tetradecyl Amine Oxide

In general, it is preferred to use tertiary amine oxides, especially trialkyl amine oxides, according to the following representative structure: 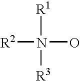
where R² represents C₁₄ alkyl, and R¹ and R³ are each C₁₋₃, most preferably methyl. When R¹ and R³ are both methyl and R² is alkyl averaging C₁₄, the structure for dimethyltetradecylamine oxide, a particularly preferred amine oxide, is obtained. Representative examples of this particular nonionic surfactant include those sold under the name AMMONYX® MO (available from Stepan Chemical Company) and BARLOX® 14 (available from Lonza, Inc.).

The R² group in the representative structure above is preferably a straight-chain moiety, although some degree of branching is acceptable at about the gamma carbon or further from the nitrogen atom. Generally, the more distal the carbon relative to the amine group, the longer the branched chain may be. Amine oxides having a branched R² group are thus considered to be within the scope of the present invention as long as the longest chain of the branched R² group contains no more than about 14 carbon atoms. The amine oxide is present in a thickening effective amount, which comprises about 0.1 to 5.0%, more preferably about 0.1 to 3.0%, and most preferably from about 0.2 to 1.5% by weight of the total cleaning formulation of the present invention.

A key consideration in the present invention concerns the chain length of the amine oxide R² group. It is important that the amine oxide contain a relatively high percentage of R² as tetradecylalkyl groups, which may be contrasted with the amine oxides described and claimed in U.S. Pat. No. 5,462,689 to Choy, et al, of common assignment herewith and incorporated by reference thereto, which describes thickening systems based on alkyl groups averaging 16 carbon atoms. Aside from those instances in which R² consists virtually exclusively of C₁₄ alkyl chain groups, mixtures of alkyl groups containing shorter (e.g. C₁₀₋₁₂) and longer (e.g. C₁₅₋₁₈) chain lengths may also be used, provided that the average alkyl group length is C₁₄. For example, amine oxides containing alkyl chain lengths much shorter than about C₁₄ tend to be hydrophilic and rather soluble in aqueous solution. These shorter chain alkyl groups in combination with the counterion therefore result in mixtures that do not exhibit large extensional properties, and subsequently exhibit less preferred viscoelastic thickening characteristics. On the other hand, it is also known that R² alkyl groups with chain lengths much longer than about C₁₆₋₁₈ (or those with even more carbon atoms) tend to be increasingly hydrophobic with chain length and are therefore not readily soluble in the aqueous systems. The amine oxide may contain a relatively high percentage of the C₁₄ alkyl group (as considered prior to mixing with hexadecyl amine oxide). In a first embodiment, the amine oxide is about 80% C₁₄; in a second embodiment the amine oxide is about 95% C₁₄; and in a third is about 99% C₁₄.

Expressed alternatively, a value for the actual amount of C₁₄ amine oxide (A_{cf}) is the product of total C₁₄ (expressed in weight percentage) and the fraction of C₁₄ amine oxide (expressed as a ratio of C₁₄ total amine oxide.) The foregoing weight percentages are intended to be exemplary; the amount of C₁₄ amine oxide is defined by the desired rheological parameters of Tau, G₀, Tau/G₀ and viscosity as taught herein.

It is thought that the tetradecyl amine oxide helps to solubilize the hexadecyl amine oxide, as well as contributing to the viscosity of the system. The ternary system of two amine oxides and counterion further affords an enhanced substantivity to the cleaning active. Thus, on partial clogs, the compositions of the present invention will adhere, thereto, resulting in longer contact or “dwell” time. Such longer contact time results in enhanced clog dissolution or breakdown and consequent flow improvement.

### Organic Counterion

The organic counterion is selected from the group consisting of aryl and alkyl carboxylates, aryl and alkyl sulfonates, sulfated aryl alcohols, and mixtures thereof. The aryl compounds may be derived from benzene or napthalene and may be substituted or not. The counterion may include substituents which are chemically stable with the active cleaning compound. Preferably, the substituents are alkyl or alkoxy groups of 1-4 carbons, halogens and nitro groups, all of which are stable with most actives, including hypochlorite. The counterions may be added in acid form and converted to the anionic form in situ, or may be added in anionic form.

Substituents such as hydroxy or amine groups are suitable for use with some non-hypochlorite cleaning actives, such as solvents, surfactants and enzymes. If present, a substituent may be in any position on the rings. If benzene is used, the para (4) and meta (3) positions are preferred. The counterion is added in an amount sufficient to thicken and result in a viscoelastic rheology. In general, lower levels of counterion, in conjunction with the C₁₆ amine oxide, promote the development of higher viscosities. A first range is 0.1 to 3.0; a second range is 0.2 to 1.0; and a third range is 0.2 to 0.8; all measured as weight percent of the composition. A first weight ratio of C₁₆ amine oxide to counterion is between about 3:1 and 1:1 a second ratio is about 2:1 to 3:2. The ratio dependence indicates that the structure of the mixed micelle is the determining factor in obtaining extensional properties. Without limiting to a particular theory, it is thought that the counterion promotes the formation of elongated rod-like micelles with the amine oxide. These micelles can form a network which results in efficient thickening. In one embodiment, the counterion is minimally or non surface-active. Additionally, the counterion acts to promote phase-stability of the composition.

### Co-Surfactants

Thickening can be enhanced, and low temperature phase stability improved, through the addition of a cosurfactant selected from the group consisting of quaternary ammonium compounds, betaines, sarcosinates, taurides, and mixtures thereof. Additionally, non-thickening cosurfactants can be added for other purposes as desired, e.g. detergency, solubilization, wetting, etc. Amine oxides having R groups other than C₁₄ and/or C₁₆ may be added so long as the rod micelle formation is not adversely affected. The foregoing cosurfactants may be added in an amount effective to accomplish their desired function, and generally in a weight percentage range of 0% to about 5%, more preferably 0.1% to about 2%.

### pH Adjusting Agent

pH adjusting agents may be added to adjust the pH. Buffers, on the other hand, may act to maintain pH, and in this instance, alkaline pH is favored for purposes of both rheology and maintaining hypochlorite stability. Examples of buffers include the alkali metal phosphates, polyphosphates, pyrophosphates, triphosphates, tetraphosphates, silicates, metasilicates, polysilicates, carbonates, hydroxides, and mixtures of the same. Control of pH may be necessary to maintain the stability of the halogen source and to avoid protonating the amine oxide. For the latter purpose, the pH should be maintained above the pKa of the amine oxide. Thus for the amine oxides, the pH should be above about 6. Where the active halogen source is sodium hypochlorite, the pH is maintained above about pH 10. Most preferred for this purpose are the alkali metal hydroxides, especially sodium hydroxide. The total amount of pH adjusting agent/buffer including that inherently present with bleach plus any added, can vary as necessary to adjust pH, for example, from about 0% to 5%.

### Electrolyte

An electrolyte may be added to promote viscosity development. Electrolytes function, on the one hand, to provide sources of ion (generally anions) in aqueous solution. This provides a charged medium in which the surfactants can interact, providing the rheology of the invention. Some compounds will serve as both buffer and electrolyte. These particular buffers/electrolytes are generally the alkali metal salts of various inorganic acids, to wit: the alkali metal salts of phosphates, polyphosphates, pyrophosphates, triphosphates, tetraphosphates, silicates, metasilicates, polysilicates, carbonates, hydroxides, and mixtures of the same. Certain divalent salts, e.g. alkaline earth salts of phosphates, carbonates, hydroxides, etc., can function singly as buffers. If such compounds were used, they would be combined with at least one of the previous electrolytes/buffers mentioned to provide the appropriate pH adjustment. Bleach-stable organic materials, such as gluconates, succinates, maleates, and inorganic materials such as sodium chloride or sodium sulfate could be utilized as electrolytes to maintain the ionic strength for the desired rheology. It may be noted that where sodium hypochlorite is the cleaning active, sodium chloride is typically present as a by-product of the hypochlorite formation, and additional electrolyte is generally unnecessary. An especially preferred electrolyte/buffer is an alkali metal silicate. The preferred silicate is sodium silicate, which has the empirical formula Na₂O:SiO₂. The ratio of sodium oxide:silicon dioxide is about 1:4 to 2:1, more preferably about 1:2. The amount of deliberately added electrolyte can vary from about 0% to 10.0%, preferably from about 0.1% to 5%.

### Adjuncts

The composition of the present invention can be formulated to include such components as fragrances, coloring agents, whiteners, solvents, chelating agents and builders, which enhance performance, stability or aesthetic appeal of the composition. From about 0.01% to about 0.5% of a fragrance such as those commercially available from International Flavors and Fragrance, Inc. may be included in any of the compositions of the first, second or third embodiments. Dyes and pigments may be included in small amounts. Ultramarine Blue (UMB) and copper phthalocyanines are examples of widely used pigments which may be incorporated in the composition of the present invention. Suitable builders which may be optionally included comprise carbonates, phosphates and pyrophosphates, exemplified by such builders function as is known in the art to reduce the concentration of free calcium or magnesium ions in the aqueous solution. Certain of the previously mentioned buffer materials, e.g. carbonates, phosphates, phosphonates, polyacrylates and pyrophosphates also function as builders.

Another embodiment of the present invention is a drain cleaning formulation which includes:
(a) a viscoelastic thickener having the rheological properties described herein, with particular reference to FIG. 4; and
(b) a drain opening active.

Component (a) comprises the viscoelastic thickener as described previously.

The drain opening active is an acid, base, solvent, oxidant, reductant, enzyme, surfactant or thioorganic compound, or mixtures thereof, suitable for opening drains. Such materials include those as previously described in the first embodiment which act by either chemically reacting with the clog material to fragment it or render it more water-soluble or dispersible, physically interacting with the clog material by, e.g. adsorption, absorption, salvation, or heating (i.e. to melt grease), or by enzymatically catalyzing a reaction to fragment or render the clog more water-soluble or dispersible. Particularly suitable are alkali metal hydroxides and hypochlorites. Combinations of the foregoing are also suitable. The drain opener may also contain various adjuncts as known in the art, including corrosion inhibitors, dyes and fragrances.

Yet another embodiment of the present invention is a drain cleaning formulation which includes:
(a) a viscoelastic thickener having the rheological properties described herein, with particular reference to FIGS. 4 and 5 (independantly or combined) comprising a hexadecyl dialkyl amine oxide, a tetradecyl dialkyl amine oxide, and an organic counterion;
(b) an alkali metal hydroxide;
(c) an alkali metal silicate;
(d) an alkali metal carbonate; and
(e) a drain opening active.

The alkali metal hydroxide is preferably potassium or sodium hydroxide, and is present in an effective amount, for example, between about 0.5% and 20%. One alkali metal silicate has the formula M₂O(SiO)ₙ where M is an alkali metal and n is between 0.5 and 4. Preferably M is sodium and n is 2.3. The alkali metal silicate is present in an amount of about 0% to 5%. The preferred alkali metal carbonate is sodium carbonate, at levels of between about 0% and 5%. About 1% to 10% cleaning active, is present, preferably about 4% to 8%. Sodium chloride or similar salts may be added as a densifying agent to result in a composition density greater than that of water, thus aiding in penetration through standing water.

Viscoelasticity is defined as a liquid that has both elastic (solid-like) properties and viscous (only liquid) behavior. Solutions made from C₁₂ or C₁₄ amine oxides exhibit very little viscoelastic properties, as demonstrated by a frequency sweep with a Bohlin VOR rheometer. However, the use of the C₁₆ amine oxide in conjunction with sodium xylene sulfonate, gives rise to a large viscoelastic response, with a relaxation time far in excess of those outlined in the art. Another example of the different rheological properties between the C_{12,14} and C₁₆ AO/SXS systems is the shear viscosity profile as a function of shear. At low shear rates, both the C₁₂ and C₁₄ AO/SXS behave like Newtonian liquids; that is, the viscosity is constant as a function of shear rate. When the shear rate is higher, however, slight shear thickening occurs, with the viscosity increasing as the shear rate increase. In contrast, the C₁₆ AO/SXS always shows shear thinning behavior; that is, the viscosity decreases with shear rate.

Rod-like micelles result in extensional viscosity based upon extensional flow. The extensional flow is uniaxial and, if the molecules are long but naturally coiled, as in rod micelles, the extensional flow will literally straighten the molecules out, causing them to occupy much more volume than in a normal three-dimensional flow field. Because of the constricted movement and the resulting loss of volume to move about, the viscosity (extensional) goes up by factors of 10 to 1,000.

The composition may have utility as a hard surface cleaner. The thick solutions are clear and transparent, and can have higher viscosities than hypochlorite solutions of the art. Because viscoelastic thickening is more efficient, less surfactant is needed to attain the viscosity, and chemical and physical stability of the composition generally is better. Less surfactant also results in a more cost-effective composition. As a hard surface cleaner, the viscoelastic rheology prevents the composition from spreading on horizontal sources and thus aids in protecting nearby bleach-sensitive surfaces. The viscoelasticity also provides the benefits of a thick system, e.g. increased residence time on non-horizontal surfaces. On non-horizontal surfaces, the composition flows off at a much slower rate, and a film is left which can yield very effective cleaning.

Advantageously, the surfactant thickening system is not diminished by ionic strength, nor does it require ionic strength for thickening. The viscoelastic compositions of the present invention are phase-stable and retain their rheology in solutions with more than about 0.5 weight percent ionizable salt, e.g. sodium chloride and sodium hypochlorite, corresponding to an ionic strength of about 0.09 g-ions/Kg solution. It is expected that the viscoelastic rheology would remain even at ionic strengths of at least about 6 g-ions/Kg. The surfactant system also does not significantly degrade hypochlorite even after prolonged (26 months) storage. Compositions ranging from 0.8 to 1.25 weight percent total surfactant did not result in appreciable loss of hypochlorite.

### EXPERIMENTAL

### Table I

Examples 1-4 of Table I illustrate the effects of varying C₁₄ amine oxide at a constant level of C₁₆ amine oxide and SXS counterion. The remaining Examples are various levels of counterion and C₁₄ amine oxide. In addition to the ingredients shown in the table, the formulations included 6% NaOCl, 1.85% NaOH, 4.7% sodium chloride, 0.11% sodium silicate, and the balance, water. All examples were phase stable after storage for at least 6 months at 2° C. Viscosities herein were measured with a Brookfield viscometer, and Tau and G₀ values were obtained using Bohlin rheometer.

| | Example | | | | | | |
|---|---|---|---|---|---|---|---|
| Ingredient | 1 | 2 | 3 | 4 | 5 | 6 | 7 |
| C₁₆ Amine Oxide | 0.7 | 0.6 | 0.7 | 0.7 | 0.7 | 0.7 | 0.7 |
| C₁₄ Amine Oxide | 0.1 | 0.3 | 0.5 | 0.61 | 0.49 | 0.27 | 0.42 |
| Counterion | 0.35 | 0.35 | 0.35 | 0.39 | 0.05 | 0.5 | 0.5 |
| Viscosity | 1784 | 1048 | 1448 | 1456 | 928 | 1568 | 1080 |
| Tau | 5.95 | 1.7 | 1.3 | 1.1 | 2.8 | 1.4 | 1.07 |
| G₀ | 2.47 | 3.1 | 5.4 | 6.77 | 1.89 | 5.3 | 5.56 |
| Tau/G₀ | 2.41 | 0.55 | 0.24 | 0.16 | 1.48 | 0.26 | 0.19 |
| Partial Clog | 79% | 75% | 83% | 80% | 81% | 81% | 80% |
| Full Clog | 2.5 | 2-3 | 2-3 | 2-3 | 3 | 2-3 | 2-3 |

Examples 8-10 of Table II illustrate the effects of varying C₁₆ amine oxide at a constant level of C₁₄ amine oxide and SXS counterion. The remaining Examples are various levels of counterion and C₁₆ amine oxide. In addition to the ingredients shown in the table, the formulations included 6% NaOCl, 1.85% NaOH, 4.7% sodium chloride, 0.11% sodium silicate, and the balance, water. Ingredients are reported in weight percentages of total composition. All examples were phase stable after storage for at least 6 months at 2° C. For all Tables, viscosities reologies were measured with a Brookfield viscometer, while Tau and G₀ were obtained using a Bohlin rheometer. Drain opening performance was measured on full and partial hair clogs, as follows: partial hair clogs were made using 2 g of hair, cut into approximately 15-18 cm length. This hair was then placed in a test sink, and rinsed into the drain. An unclogged drain was found to have a flow rate averaging about 15-22 Liters/minute; a flow rate of about 12 L/minute or less was considered to be a slow, or partially clogged, drain. Full hair clogs were made by mixing 20 g of hair (cut into 4 cm lengths) with 10 g of soap. The mixture was shaped into a ball, placed into a test drain, and compressed in-situ (from both sides) so that it remained in place and intact when 1 L water was poured into the drain.

Formulations were tested by pouring 6-10 L of water down the drain, followed by 500 ml of test formulation. For full hair clogs, improvement was measured by the time to clear (rather than flow rate improvement), since flow rate is restored to its normal value. It has been found that once a base amount of hair has been dissolved, the remaining hair has insufficient volume to clog the drain and will simply be rinsed away, thus restoring the drain to 100%. Full clog removal was visually determined when the clog was substantially, or fully, washed away. After full clog removal, a water flow rate was about 15-22 L/minute. To determine percentage of clog dissolved/removed, after the completion of each, the hair remaining after treatment was collected, rinsed, dried overnight at 49° C., and weighed. Results are reported as percentage of clog dissolved/removed. Time to clear is reported in minutes.

TABLE II

| | Example | | | | | |
|---|---|---|---|---|---|---|
| Ingredient | 8 | 9 | 10 | 11 | 12 | 13 |
| C₁₆ Amine | 0.9 | 0.8 | 0.7 | 0.5 | 0.84 | 0.87 |
| Oxide | | | | | | |
| C₁₄ Amine | 0.5 | 0.55 | 0.5 | 0.3 | 0.33 | 0.62 |
| Oxide | | | | | | |
| Counterion | 0.35 | 0.35 | 0.35 | 0.20 | 0.5 | 0.05 |
| Viscosity (cP) | 3528 | 2280 | 1248 | 640 | 2664 | 888 |
| Tau (sec) | 2.7 | 1.8 | 1.44 | 1.5 | 2.25 | 1.54 |
| G₀ (Pa) | 8.4 | 7.1 | 5.17 | 2.2 | 7.26 | 3.5 |
| Tau/G₀ | 0.32 | 0.25 | 0.28 | 0.68 | 0.31 | 0.44 |
| Partial Clog | 90% | 85% | 80% | 60% | 85% | 75% |
| Full Clog | 2-3 | 2-3 | 3-4 | 3-4 | 2-3 | 2-3 |

Tables III and IV below illustrate various embodiments of the present invention as defined by result for combinations of viscosity and Tau, and viscosity and G₀, respectively. The viscosity, Tau, and G₀ data is is quantative, while the performance data is qualitative. Thus, performance on full and partial clogs is evaluated as being “fair” or “good.” The table is a performance assessment of the formulation on full and partial clogs. A clear drain normally flows at a rate of 15-22 L/min. Full clogs are defined as those that prevent liquid flow, while partial clogs permit under 2 L of flow after one minute. The clogs were prepared and tested as described above. For purposes of the Table III, Tau in the range of 12-20 seconds is considered to be “high,” while the range of 3-12 seconds is “medium,” and “low” Tau is in the range of 0.5-3 seconds. For purposes of the Table IV, a G₀ of 3-15 Pa is “high,” a G₀ of 1-3 Pa is ‘medium,” and 0.2-1 Pa is “low.” For purposes of both Tables III and IV, viscosity in a range of 2000-4000 cP is “high,” a range of 1000-2000 cP is “medium,” and 20-1000 cP is “low.”

TABLE III

| Viscosity | Tau | Full Clogs | Partial Clogs |
|---|---|---|---|
| 3328 | 13.08 | Good | Fair |
| 2504 | 4.52 | Very Good | Good |
| 2280 | 1.8 | Good | Very Good |
| 592 | 4.07 | Very Good | Fair |
| 928 | 2.8 | Good | Fair |
| 1048 | 1.7 | Fair | Good |

TABLE IV

| Viscosity | Go | Full Clogs | Partial Clogs |
|---|---|---|---|
| 3256 | 7.45 | Good | Fair |
| 1448 | 5.4 | Good | Good |
| 1784 | 2.47 | Very Good | Very Good |
| 1456 | 6.77 | Fair | Fair |
| 1112 | 3.15 | Good | Very Good |
| 176 | 2.01 | Fair | Fair |

Table V further correlates rheology with performance benefits of the present invention. The Examples all included 6% NaOCl, 1.85% NaOH, 4.7% sodium chloride, 0.11% sodium silicate, and the balance, water. Tetradecyl amine oxide, Hexadecyl amine oxide, and SXS counterion levels are as shown in the Table. Experimental design is the same as reported in connection with Tables I and II. Full and partial clog removal was measured as described above.

TABLE V

| | C₁₆ | C₁₄ | | | | | | |
|---|---|---|---|---|---|---|---|---|
| | amine | amine | | | | | Full | Partial |
| Example | oxide | oxide | SXS | Viscosity | Tau | G₀ | Clogs | Clogs |
| 14 | 0.9 | 0.1 | 0.49 | 2504 | 4.52 | 4.4 | 2:03 | 73 |
| 15 | 0.9 | 0.05 | 0.63 | 1112 | 1.82 | 3.15 | 4:08 | N/A |
| 16 | 0.7 | 0.05 | 0.49 | 936 | 3.15 | 1.89 | 2:43 | 78 |
| 17 | 0.9 | 0.05 | 0.35 | 3328 | 13.08 | 4.33 | 5:15 | 68 |
| 18 | 0.5 | 0.05 | 0.35 | 592 | 4.07 | 0.97 | 2:04 | 74 |

While described in terms of the presently preferred embodiment, it is to be understood that such disclosure is not to be interpreted as limiting. Various modifications and alterations will no doubt occur to one skilled in the art after having read the above disclosure. Accordingly, it is intended that the appended claims be interpreted as covering all such modifications and alterations as fall within the true spirit and scope of the invention.

1. A viscoelastic thickening system as defined by the area bounded by points A, B, C, D, E, F and G of FIG. 4.

2. The viscoelastic thickening system of claim 1 wherein the system comprises a mixture of three surfactants.

3. The viscoelastic thickening system of claim 2 and further including a cleaning active.

4. A viscoelastic thickening system having the rheological properties of:
a. a Tau between about 0.1 and 8 seconds;
b. a G₀ between about 1 and 10 Pa;
c. a Tau/G₀ between about 0.25 and 6 sec/Pa; and
d. a viscosity between about 20 and 4000 cP.

5. The viscoelastic thickening system of claim 4 wherein the system comprises a mixture of three surfactants.

6. The viscoelastic thickening system of claim 5 wherein the surfactants include a hexadecyl amine oxide, a tetradecyl amine oxide, and an organic counterion

7. The viscoelastic thickening system of claim 5 and further including a cleaning active a cleaning active.

8. A liquid cleaning composition comprising:
(a) a thickening system consisting essentially of a first amine oxide, a second amine oxide and an organic counterion; and wherein the composition has a Tau between about 0.5 and 20 seconds; a G₀ between about 1 and 10 Pa; a Tau/G₀ between about 0.1 and 8 sec/Pa; and a viscosity between about 20 and 4000 cP; and
(b) optionally, a cleaning active;

9. The cleaning composition of claim 8 wherein
the cleaning active is a hypochlorite-releasing compound.

10. The cleaning composition of claim 8 wherein
the first amine oxide is tetradecyl dialkyl; the second amine oxide is hexadecyl dialkyl; the organic counterion is aryl or C₂₋₆ alkyl sulfonate, aryl or C₂₋₆ alkyl carboxylate, sulfated alkyl or aryl alcohol, and mixtures thereof.

11. The cleaning composition of claim 10 wherein
the counterion is an alkali metal aryl sulfonate.

12. The cleaning composition of claim 8 and further including
a pH adjusting agent.

13. A thickened viscoelastic drain opening composition comprising, in aqueous solution:
(a) a drain opening active; and
(b) a viscoelastic thickening system consisting essentially of a hexadecyl dialkyl amine oxide, a tetradecyl amine oxide and an organic counterion in an amount effective for thickening the composition to a viscosity of at least about 20 cP; and wherein the composition has a density greater than that of water.

14. The thickened viscoelastic drain opening composition of claim 13, wherein
The thickening system has the rheological properties of:
a. a Tau between about 0.5 and 20 seconds;
b. a G₀ between about 0.2 and 15 Pa
c. a Tau/G₀ between about 0.1 and 8 sec/Pa; and
a viscosity between about 20 and 4000 cP.

15. The drain opening composition of claim 14 wherein
the drain opening active is selected from the group consisting of acids, bases, oxidants, reductants, solvents, enzymes, detergents, thioorganic compounds, and mixtures thereof.

16. The drain opening composition of claim 14 wherein
the organic counterion is aryl or C₂₋₆ alkyl sulfonate, aryl or C₂₋₆ alkyl carboxylate, sulfated alkyl or aryl alcohols, and mixtures thereof.

17. The composition of claim 16 wherein
the drain-opening active is sodium hypochlorite, present in an amount of about 1-10 percent by weight, and wherein the composition further comprises:
(a) 0.5 to 20 weight percent of an alkali metal hydroxide;
(b) 0 to 5 weight percent of an alkali metal silicate; and
(c) 0 to 5 weight percent of an alkali metal carbonate.

18. A method for clearing restrictions caused by organic materials in
drain pipes comprising:
(a) introducing into a drain at least one liquid which is characterized by a Tau between about 0.5 and 15 seconds, a G₀ between about 0.2 and 15 Pa, a Tau/G₀ between about 0.1 and 8 sec/Pa, and a viscosity between about 20 and 4000 cP, and wherein the liquid includes a cleaning-effective amount of a drain cleaning active; and
(b) allowing the composition to remain in contact with the organic restriction material to react therewith.

19. The method of claim 18 wherein the liquid includes a viscoelastic thickening system consisting essentially of a hexadecyl dialkyl amine oxide, a tetradecyl amine oxide and an organic counterion.

20. The method of claim 19 wherein
a ratio of C₁₆ amine oxide to counterion is between about 3:1 and 1:1.
